(19) United States
(12) Patent Application Publication
(10) Pub. No.: US 2007/0108364 A1
(43) Pub. Date: May 17, 2007

(54) ASSEMBLY FOR DECK ACCESSORIES

(76) Inventor: JACK METHENY, West Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/550,489

(22) Filed: Oct. 18, 2006

Related U.S. Application Data
(63) Continuation-in-part of application No. 11/273,394, filed on Nov. 14, 2005.

(51) Int. Cl. A01K 97/10

(52) U.S. Cl. 248/541

(57) ABSTRACT

A bracket assembly is provided for mounting a pole of a deck accessory to a deck rail. The bracket assembly includes a first bracket having a channel for receiving the deck rail so as to mounted thereto, without the used of hardware or tools. An insert may be provided in a collar on the first bracket so as to reduce the diameter of the collar, and thereby accommodate poles having different diameters. A lower bracket may be provided with a collar and insert to receive the lower end of a deck accessory pole. The lower bracket is mounted to a block which contacts one or more of the vertical deck posts, without being secured thereto, for aligning the second bracket beneath the first bracket. An accessory item may be secured using the assembly. Examples of accessory items include, without limitation, a flag pole holder, a shepherd's hook, a beverage holder, a solar light, a sundial, a decorative item, a tikki torch, and an umbrella.

### RELATED APPLICATION

This application is a continuation-in-part of and claims priority to U.S. patent application Ser. No. 11/273,394, filed Nov. 14, 2005, incorporated by reference herein in its entirety.

### BACKGROUND OF THE INVENTION

Decks on residential homes, cottages and cabins are popular in many parts of the country. Accessories for the decks are also popular, such as umbrella stands, tiki torches, flag poles, canopies, solar lights, grills, and even satellite dishes. Many of these accessories include a pole which is mounted to the floor of the deck or to the deck railing. Various forms of brackets have been used for securing the accessory pole to the deck rail, and usually require clamps, screws or other hardware to secure the bracket to the deck rail. Once mounted, the brackets are fixed and not movable, without leaving unsightly marks and blemishes on the rail from the hardware.

Therefore, a primary objective of the present invention is the provision of an improved bracket assembly for mounting a pole to a deck rail.

Another objective of the present invention is a provision of a bracket assembly which mounts to a deck rail without the use of hardware, so as to support a pole of a deck accessory.

A further objective of the present invention is a provision of a bracket assembly which is slidable along a deck for supporting an accessory pole adjacent the deck rail.

A further objective of the present invention is a provision of a bracket assembly which can be quickly and easily mounted to a deck rail without the use of tools.

Yet another objective of the present invention is a provision of a bracket assembly for a deck rail which accommodates poles having different diameters.

Still another objective of the present invention is a provision of deck rail bracket assembly having interchangeable inserts with varying diameters to hold poles having different diameters.

Another objective of the present invention is a provision of a bracket assembly for a deck rail to hold accessories, wherein the assembly is economical to manufacturer, and durable and safe in use.

One or more of these and/or other objectives that will become apparent from the following description of the invention.

### BRIEF SUMMARY OF THE INVENTION

The bracket assembly of the present invention is intended to hold a pole of a deck accessory such as a tiki torch, umbrella, flag pole, and the like. The assembly includes a first bracket having a channel for slidably receiving the deck rail and being mounted thereto without the use of hardware or tools. The first bracket includes a collar with a hole. One or more inserts are provided for insertion into the collar hole, with each insert having a hole with different diameters. Thus, the pole of a deck accessory can be inserted through the collar, or through a selected insert placed within the collar. The assembly includes a second lower bracket which also has a collar with one or more inserts with varying diameters, so as to accommodate poles having different diameters. The lower bracket is mounted to a block which engages at least one upright post of the deck so as to align the second bracket with the first bracket without the use of hardware or tools.

According to one aspect of the present invention, an assembly for a deck rail supported on a plurality of vertical posts extending upwardly from a deck floor is provided. The assembly includes a plate mountable to the railing without the use of hardware or tools, a collar extending outwardly from the plate, a hole disposed within the collar. The plate has an upper lip adapted for placement on a top of the deck rail. The plate has a lower ledge for placement on a bottom of the deck rail. A support member is adapted to be pressed in place against one of the vertical posts to secure the assembly in place. The accessory may include a handle adapted for pressing the support member in place against the one of the vertical posts. An accessory item having a pole for placement within the hole disposed within the collar may also be used. A stop member may be positioned on the pole to retain the pole in position within the collar. The accessory item may be, for example, a flag pole holder, a shepherd's hook, a beverage holder, a solar light, a sundial, a decorative item, a tikki torch, and an umbrella.

### BRIEF DESCRIPTION OF THE DRAWINGS

FIG. 1 is partial perspective view of a deck having a tiki torch mounted to the deck rail using the bracket assembly of the present invention.

FIG. 2 is a view similar to FIG. 1 showing an umbrella mounted to the deck rail using the bracket assembly of the present invention.

FIG. 3 is a perspective view of the upper bracket of the bracket assembly.

FIG. 4 is an exploded view of the upper bracket of the bracket assembly.

FIG. 5 is a perspective view of an alternative embodiment of the upper bracket.

FIG. 6 is an exploded view of the alternative bracket shown if FIG. 5.

FIG. 7 is a perspective view of the lower bracket of the bracket assembly.

FIG. 8 is an exploded view of the lower bracket.

FIG. 9 is a view of the lower bracket with an alternative insert positioned therein.

FIG. 10 is an exploded view of the lower bracket shown in FIG. 9.

FIG. 11 is an elevation view of a deck having a canopy connected to the deck rail using the bracket assembly of the present invention.

FIG. 12 is a perspective view of another embodiment of a bracket of the present invention.

FIG. 13 is an end view of the bracket of FIG. 12 being positioned onto a deck rail.

FIG. 14 is an end view of the bracket of FIG. 12 being secured to the deck rail.

FIG. 15 is an end view of the bracket of FIG. 12 secured in place on the deck rail.

FIG. 16 is a perspective view illustrating some of the many accessories which may be used with the assembly of the present invention.

FIG. 17 illustrates some of the many decorative accessories which may be used with the assembly of the present invention, including holiday-themed accessories.

### DETAILED DESCRIPTION OF THE PREFERRED EMBODIMENT

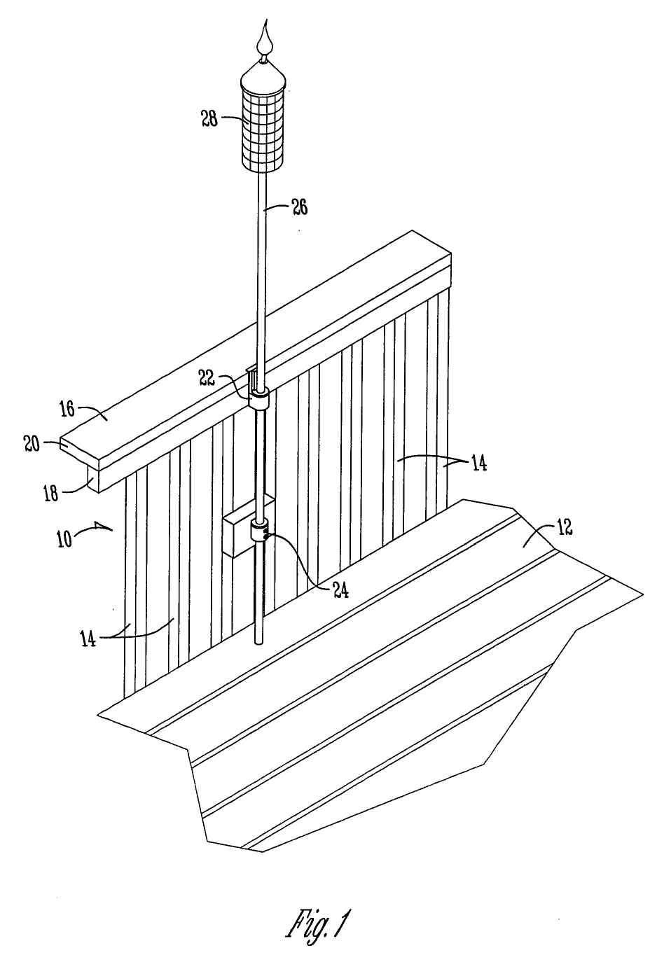

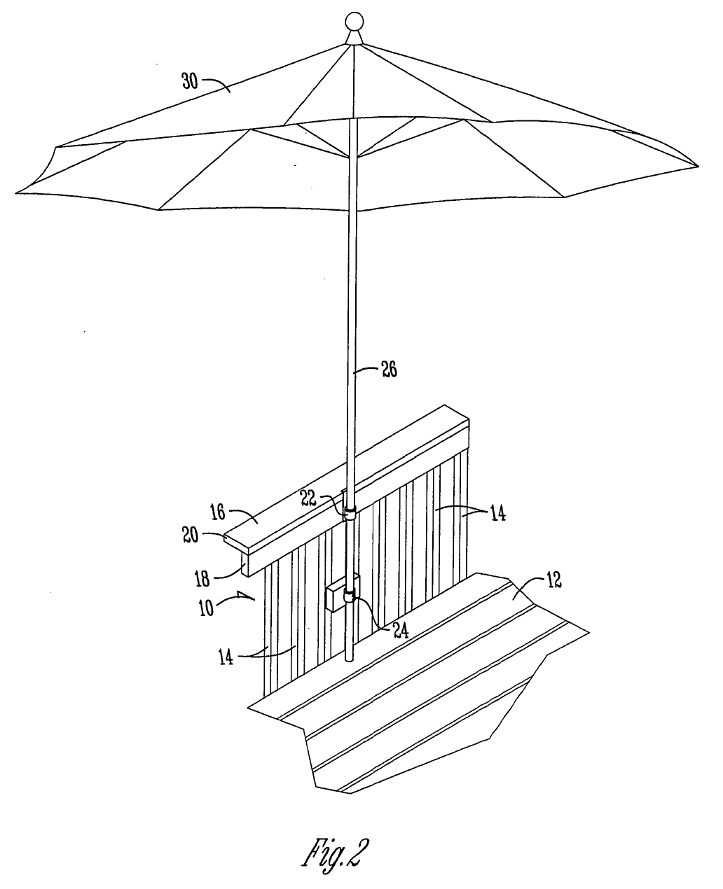

FIGS. 1 and 2 show a deck 10 having a floor 12, a plurality of vertical posts 14 secured to the floor 10 and extending upwardly, with a deck rail 16 connected to the posts 14. The rail 16 includes a facia board 18 and an upper board or sill 20. The construction of the deck 10 is conventional and does not constitute a part of the present invention.

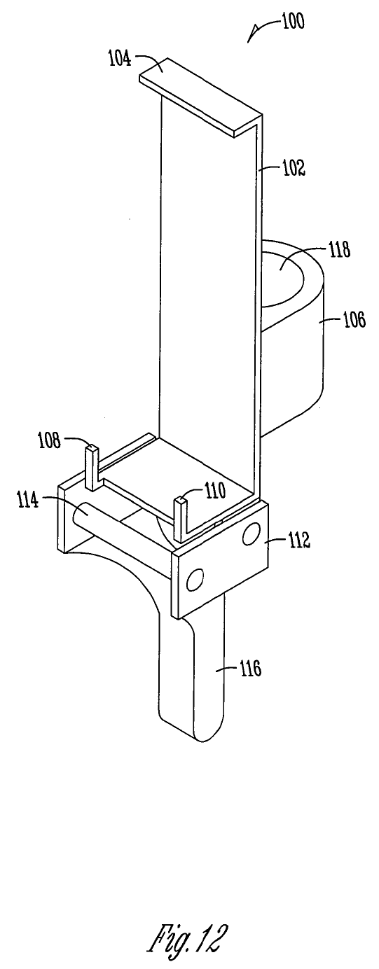

The present invention is directed towards a bracket assembly having an upper bracket 22 and a lower bracket 24, as seen in FIGS. 1 and 2. The bracket assembly is adapt to receive a pole 26 of a deck accessory, such as a tiki torch 28 (FIG. 1) or an umbrella 30 (FIG. 2). It is understood that poles for other accessories may also be mounted to the deck rail 16 using the bracket assembly of the present invention, such as a flag pole, solar lights, a satellite dish, a grill, and a canopy 32 (FIG. 11). It is also to be understood that a cross-section of the pole 26 need not be round, but can be square, have rounded corners.

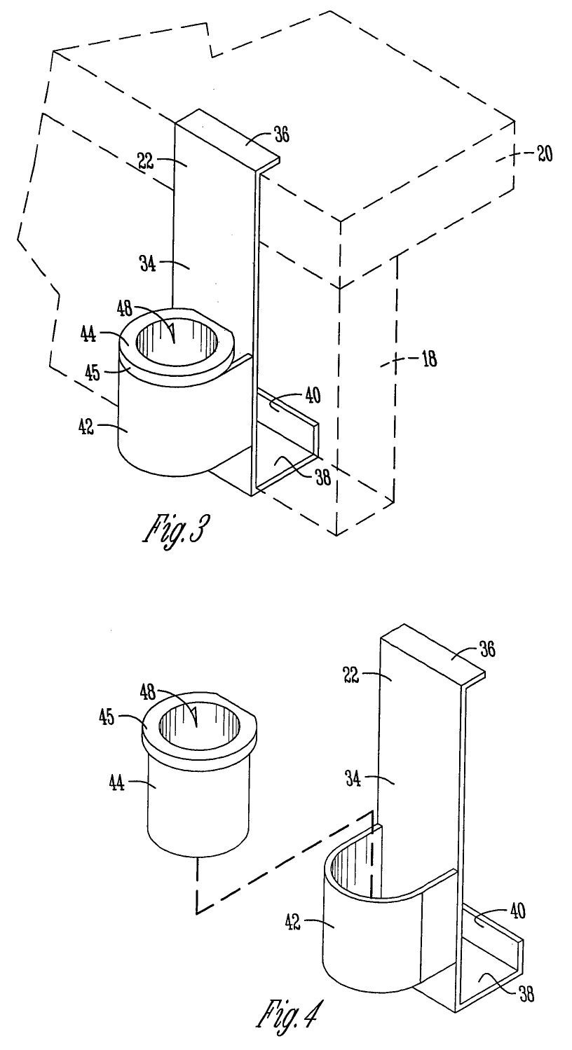

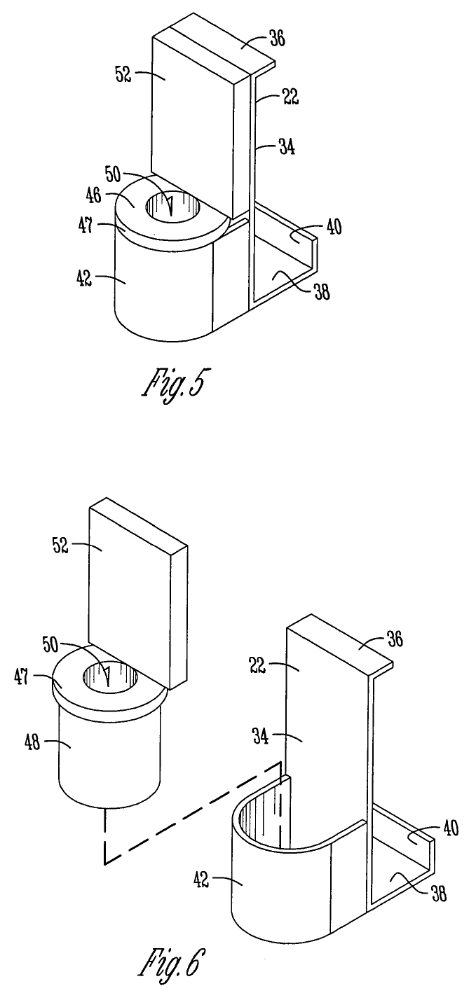

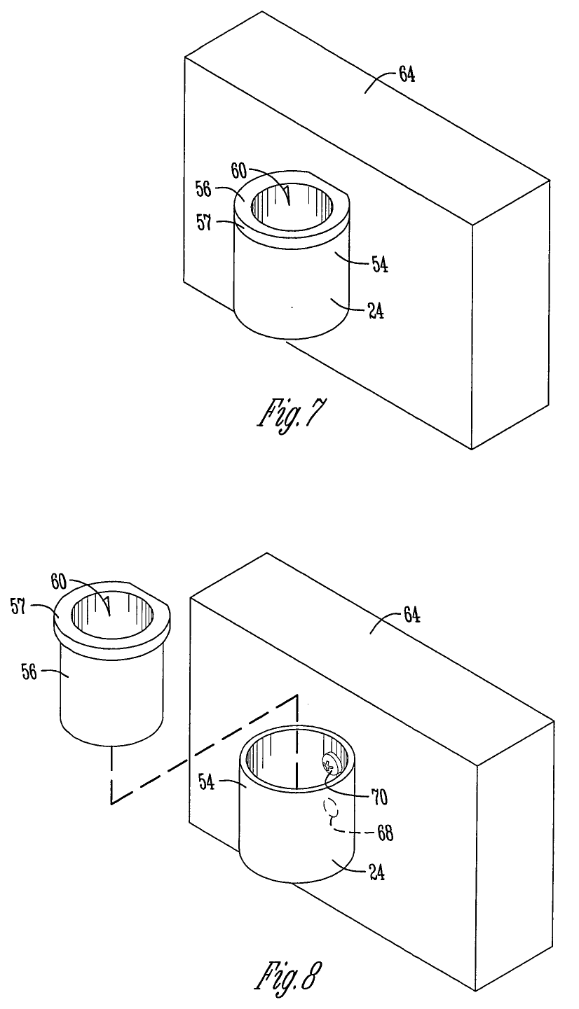

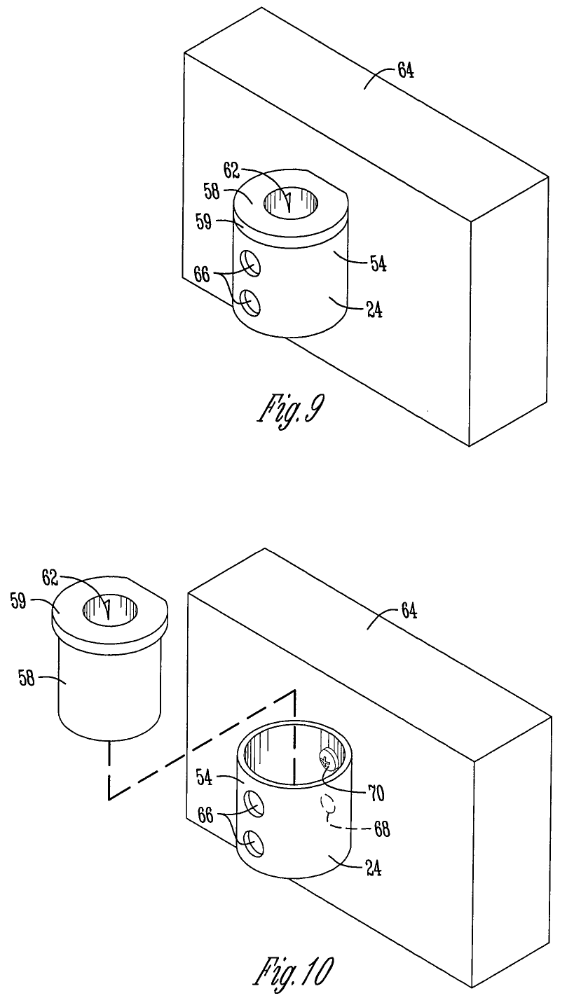

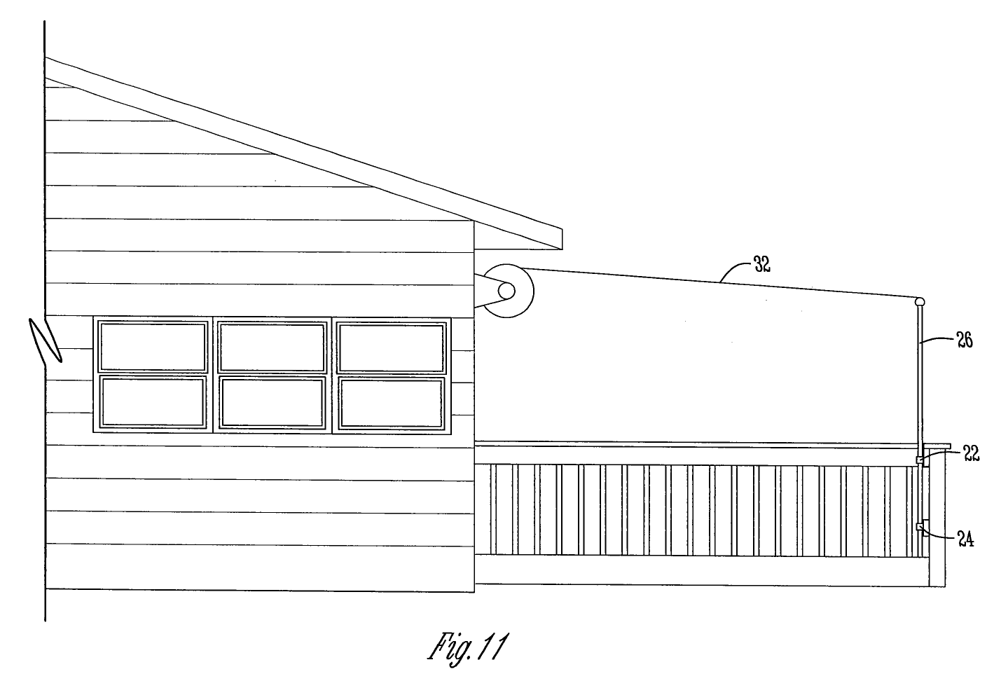

As seen in FIGS. 3 and 4, the upper bracket 22 has a front plate 34 having an inwardly turned upper lip 36, and inwardly turned lower ledge 38 terminating in an upwardly turned lip 40 which define a rearwardly-open channel for the upper bracket 22. The lower ledge 38 has a width corresponding to the thickness of the facia board 18. The height of the front plate 34 corresponds to the height of the facia board 18 and the thickness of the sill 20. For example, FIGS. 3 and 5 show brackets 22 having different heights. The upper bracket 22 is mounted onto the deck rail 16 by engaging the ledge 38 with the bottom of the facia board 18 and rotating or pivoting the upper lip 36 over the front edge of the sill 20, as seen FIG. 3. Thus, the channel of the upper bracket 22 receives the deck rail 16 so as to mount the bracket 22 on the rail 16 without the use of hardware or tools. The bracket 22 can be slid laterally along the rail 16 to a desired position. Since no screws, clamps, or other hardware is used to mount the upper bracket 22 to the deck rail 16, movement of the bracket 22 along the rail 16, or removal of the bracket 22 from the rail 16, does not leave any holes, indentations, or other blemishes which otherwise would be present from clamps and screws.

The upper bracket 22 also includes a collar 42 which is welded or otherwise secured to the plate 34. The collar 42 has a vertically oriented hole, as best seen in FIG. 4. A first insert 44 and second insert 46 may selectively be inserted into the collar 42 of the upper bracket. Each insert 44, 46 has a vertically oriented hole 48, 50 respectively. The holes in the collar 42, first insert 44 and second insert 46 have progressively smaller diameters so as to accommodate various deck accessories having poles with different diameters. For example, a large diameter pole, such as for the umbrella 30 may be inserted into the hole of the collar 42, without the inserts 44, 46. A smaller diameter pole, such as that on the tiki torch 28 may require either the first insert 44 or the second insert 46 for a snug fit in the collar 42 of the upper bracket 22. The second insert 46 may include an upwardly extending spacer extension 52 which resides between the hole 50 and the front plate 34 so as to provide further stability for the hole 26.

The lower bracket 24 includes a tube or collar 54 with a vertically oriented hole having a diameter matching the diameter of the hole in the collar 42 of the upper bracket 22. Third and fourth inserts 56, 58 may be provided for the lower collar 54, with each insert 56, 58 having a vertically oriented hole 60, 62 respectively, having diameters corresponding to the diameters of the holes 48, 50 of the first and second inserts 44, 46. The lower end of the pole 26 extends through the collar 54 and either of inserts 56, 58 which may be selectively placed in the collar 54, so as to provide enhanced stability for the pole 26. One way of describing the illustrated embodiment is as a double bind. The double binding action of the upper bracket 22 and the lower bracket 24 provide a double binding action on the pole 26 to maintain the pole in a secured position.

Preferably, the inserts 44, 46, 56, 58 each include an upper flange 45, 47, 57, and 59, respectively. The flanges 45, 47, 57, 59 engage the upper ends of the respective collars 42, 54 to keep the inserts 44, 46, 56, 58 from falling through the collars. Alternatively, the inserts can be pressed fit into the collars.

The collar 54 is mounted to a block 64. Preferably, the collar 54 includes a pair of front holes 66 and pair of rear holes 68 on opposite sides of the collar. The rear holes 68 are adapted to receive a screw for mounting the collar 54 to the block 64. The front holes 66 allow a screwdriver to extend through the collar 54 for turning the mounting screws 70.

The block 64 has a thickness corresponding to the thickness of the facia board 18 and is adapted to engage one or more of the vertical deck posts 14. Thus, the lower bracket 24 is aligned with the upper bracket 22, without being fixed to the posts 14.

In use, a person simply mounts the upper bracket 22 onto the deck rail 16 with a quick and easy rotational or pivotal action. No hardware or tools are required. The bracket position can be adjusted by sliding the bracket 22 along the rail 16. Then the pole 26 can be inserted into the collar 42 of the bracket 22, with or without one of the inserts 44, 46. The lower end of the pole 26 can then be slid into the lower bracket 24, with or without the inserts 56, 58, as needed. It is understood that the lower bracket 24 is not required for smaller deck accessories having short poles which do not extend to the floor 12 of the deck 10. Rather, such smaller accessories can be supported solely by the upper bracket 22.

The invention contemplates numerous other embodiments. Another embodiment for an upper bracket is shown in FIG. 12. Here, the upper bracket 100 includes a plate 102 having an inwardly turned upper lip 104, and an inwardly turned lower ledge which terminates in fingers 108, 110. The upper bracket is placed on a deck rail such the deck rail is secured between the upper lip 104, the inwardly turned lower ledge and the fingers 108, 110. Of course, instead of fingers 108, 110, a continuous piece could be used, more or fewer fingers could be used, or other variations in structure may be used. A collar 42 is shown which has a vertically oriented hole 118. The hole 118 is adapted for receiving a pole or similar structure.

The upper bracket 100 has a base portion 102. A first support member 114 and a second support member traverse the upper bracket 100. A handle 116 is also shown. In operation, a user presses the handle 116 to clamp the upper bracket more tightly in place, pressing in the handle brings the support member 114 against a post. Although a handle 116 is shown for convenience, the handle 116 need not be preset or alternative forms of a handle may be used. It should also be apparent that, where a long object (such as a long pole) is not being used, it is not necessary to also require a lower bracket. Accessories may be supported merely through use of the upper bracket 100.

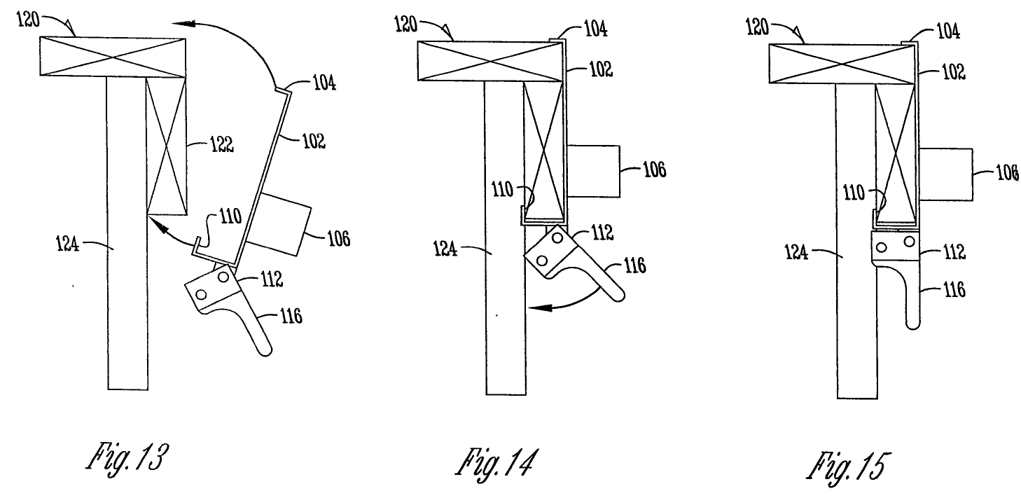

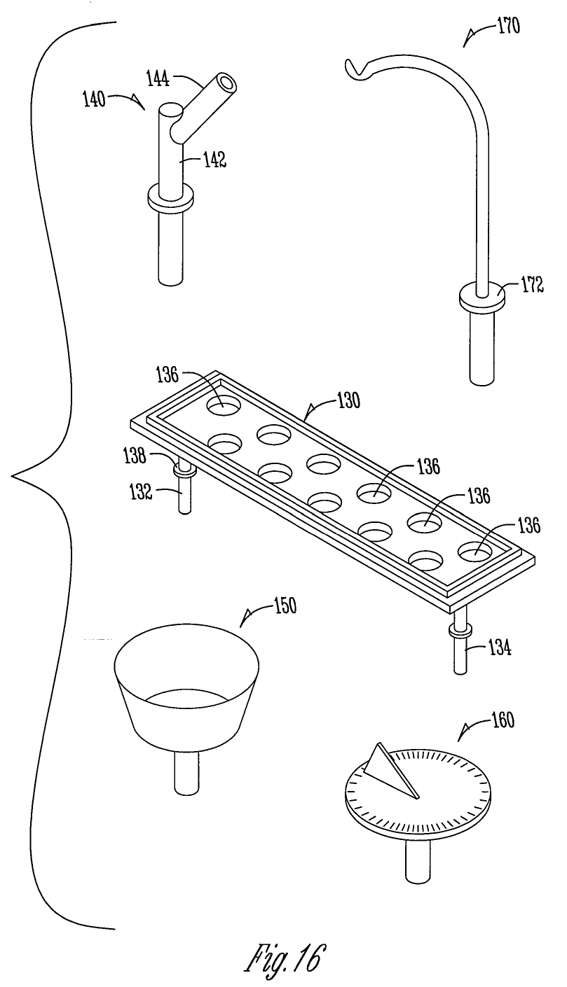

FIGS. 13-15 illustrate use of the upper bracket 100 in combination with a deck. A deck rail 120 is shown with a post 124 extending up to the deck rail 120. The deck rail shown is configured with a piece 122 extending downwardly from the rail and against the post 124. The present invention, however, contemplates that the deck may have different configurations, that which is shown is merely exemplary. As shown in FIG. 13, the upper bracket 100 is placed against the railing. FIG. 14 shows it being snuggly fit in place. FIG. 15 illustrates the upper bracket in a secured position.

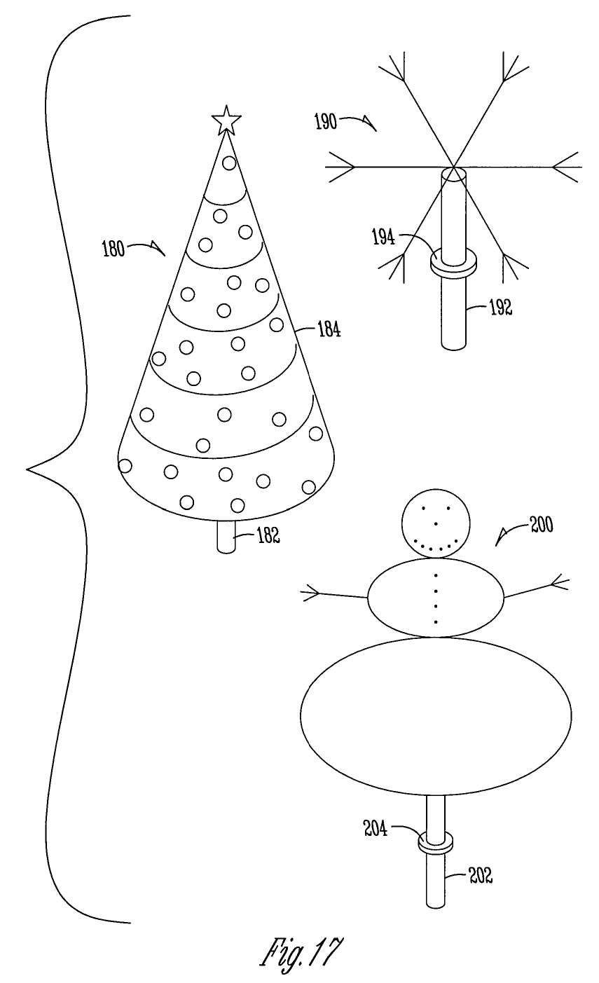

FIG. 16 illustrates some of the many different types of accessories which may be used. As shown in FIG. 16, a flag pole holder 140 may be used having a first piece 142 and a second piece 144 extending at an angle from the first piece 144. The flag pole holder 140 may be used to support a flag. A shepherd's hook 170 is shown having a base portion 172 which may be placed in the upper bracket. Note that with items such as the flag pole holder 140 and the shepherd's hook 170, no lower bracket needs to be used. FIG. 15 also illustrates a beverage holder 130 which includes multiple places to place cups. Apertures 136 provide an area in which to rest each cup, can, bottle, or other beverage containers. Legs 132 and 134 extend downwardly for placement in upper brackets. A stop member 138 is also provided on each leg. Also shown in FIG. 16 is a solar light 150 and a sun dial 160. The present invention allows for any number of deck accessories to be positioned in place using the present invention.

According to another embodiment of the present invention, ornamental deck accessories are provided. FIG. 17 illustrates examples of ornamental deck accessories. A Christmas tree 180 is shown with a tree portion 184 and a leg 182 which is placed in the upper bracket. A snowflake 190 is also shown with an arm 192 and a stop member 194 which prevents the arm from slipping down the upper bracket. A snowman 200 is also shown with an arm 202 and a stop member 204. Thus, it should be apparent that the present invention contemplates numerous types of ornamental deck accessories may be used. The deck accessories may be holiday themed with Christmas trees, snowflakes, snowman, reindeer, nativity seasons for Christmas, menorahs for Hanukah, Easter eggs or Easter bunnies for Easter; hearts for Valentine's Day; birthday cakes for birthdays; pumpkins, ghosts, or monsters for Halloween; turkeys or cornucopia's for Thanksgiving Day. Of course, these are merely representative examples. The present invention contemplates any number of variations in the specific objects, which the present invention provides a convenient manner of hanging, thereby enabling one to hang such decorations conveniently form their deck when celebrating the holidays. It should be further understood that the present invention contemplates numerous variations. For example, where various holiday themed shapes are used, these may be plain, outlined with lights so as to be visible at night. In addition, such decorations may be solar powered or corded like Christmas tree lights. The decorations may be modular so that multiple decorations may be hung on the deck railing (using multiple assemblies) and plugged together. Alternatively, instead of lights, the decorations may be luminescent outlined so as to glow in the dark. The present invention contemplates these and other types of decorative accessories.

The invention has been shown and described above with the preferred embodiments, and it is understood that many modifications, substitutions, and additions may be made which are within the intended spirit and scope of the invention. For example the present invention contemplates that different structures may be used, the structures may be formed form metal, plastic, or other materials, different types of handles may be used if a handle is used, different type of accessory items may be used, different types of deck configurations may be accommodated, and numerous other variations are within the spirit and scope of the invention.

What is claimed is:

1. An assembly for a deck rail supported on a plurality of vertical posts extending upwardly from a deck floor, the assembly comprising:
a plate mountable to the railing without the use of hardware or tools;
a collar extending outwardly from the plate;
a hole disposed within the collar;
the plate having an upper lip adapted for placement on a top of the deck rail;
the plate having a lower ledge for placement on a bottom of the deck rail;
a support member adapted to be pressed in place against one of the vertical posts to secure the assembly in place.

2. The assembly of claim 1 further comprising a handle adapted for pressing the support member in place.

3. The assembly of claim 1 further comprising an accessory item having a pole for placement within the hole disposed within the collar.

4. The assembly of claim 3 further comprising a stop member on the pole to retain the pole in position within the collar.

5. The assembly of claim 4 wherein the accessory item being a flag pole holder.

6. The assembly of claim 4 wherein the accessory item being a shepherd's hook.

7. The assembly of claim 4 wherein the accessory item being a beverage holder.

8. The assembly of claim 4 wherein the accessory item being a solar light.

9. The assembly of claim 4 wherein the accessory item being a sundial.

10. The assembly of claim 4 wherein the accessory item being a decorative item.

11. The assembly of claim 10 wherein the decorative item is holiday-themed.

12. The assembly of claim 11 wherein the holiday themed is a Christmas holiday theme.

13. The assembly of claim 1 further comprising a lower bracket having a hole.

14. The assembly of claim 1 further comprising a plurality of fingers extending upwardly from the lower ledge.

15. An assembly for a deck rail supported on a plurality of vertical posts extending upwardly from a deck floor, the assembly comprising:
a plate mountable to the railing without the use of hardware or tools;
a collar extending outwardly from the plate;
a hole disposed within the collar;
the plate having an upper lip adapted for placement on a top of the deck rail;
the plate having a lower ledge for placement on a bottom of the deck rail;
a support member adapted to be pressed in place against one of the vertical posts to secure the assembly in place;
a handle adapted for pressing the support member in place against the one of the vertical posts.

16. The assembly of claim 15 further comprising an accessory item having a pole for placement within the hole disposed within the collar.

17. The assembly of claim 16 wherein the accessory item being selected from the set consisting of a flag pole holder, a shepherd's hook, a beverage holder, a solar light, a sundial, a decorative item, a tikki torch, and an umbrella.

18. The assembly of claim 15 further comprising a stop member on the pole to retain the pole in position within the collar.

19. An assembly for a deck rail supported on a plurality of vertical posts extending upwardly from a deck floor, the assembly comprising:
a plate mountable to the railing without the use of hardware or tools;
a collar extending outwardly from the plate;
a hole disposed within the collar;
the plate having an upper lip adapted for placement on a top of the deck rail;
the plate having a lower ledge for placement on a bottom of the deck rail;
a support member adapted to be pressed in place against one of the vertical posts to secure the assembly in place;
an accessory item having a pole for placement within the hole disposed within the collar;
a stop member on the pole to retain the pole in position within the collar.

20. The assembly of claim 19 wherein the accessory item being selected from the set consisting of a flag pole holder, a shepherd's hook, a beverage holder, a solar light, a sundial, a decorative item, a tikki torch, and an umbrella.
